(19) United States
(12) Patent Application Publication
(10) Pub. No.: US 2003/0153419 A1
(43) Pub. Date: Aug. 14, 2003

(54) Tensioning idler

(76) Inventors: Yahya Hodjat, Oxford, MI (US); Keming Liu, Sterling Height, MI (US); Alexander Serkh, Troy, MI (US)

Correspondence Address: Jeffrey Thurnau, The Gates Corporation, Mail Stop 31-4-1-A3, 900 S. Broadway, Denver, CO, 80209, US

(21) Appl. No.: 10/075,828

(22) Filed: Feb. 12, 2002

(51) Int. Cl. F16D 3/00; F16H 7/08; F16F 15/10

(52) U.S. Cl. 474/101; 474/94; 74/574

(57) ABSTRACT

The invention comprises a tensioning idler. An outer belt bearing ring is resiliently engaged to an inner ring. The belt bearing ring and inner ring each rotate about an axis of rotation. The belt bearing ring is connected to the inner ring with the resilient material whereby the belt bearing ring rotates about an axis of rotation that is eccentrically moveable in a plane with respect to an inner ring axis of rotation. The resilient material imparts a belt tension as the belt bearing ring rotates. The resilient material may comprise springs, compressible fluids, incompressible fluids, or elastomers or a combination of the foregoing. The tensioner is mounted on an engine, bracket, or other device.

### FIELD OF THE INVENTION

The invention relates to a tensioning idler, and more particularly, to a tensioning idler having a belt bearing surface with an axis of rotation that is moveable in a plane with respect to an inner ring axis of rotation.

### BACKGROUND OF THE INVENTION

In prior art belt drive systems, tensioning the belt is necessary to effectively transfer power from a driver to a driven pulley. Mechanical tensioners with springs or hydraulic cylinders are known devices used in various designs. Each of these tensioners applies a tensioning force to a belt via an idler pulley on an arm. The tensioning mechanism (spring, hydraulic cylinder, etc.) is generally located outside the idler and the force is transferred through the arm to the idler.

Representative of the art is U.S. Pat. No. 4,571,222 (1986) to Brandenstein et al. which discloses a tension roller with a supporting member, pivoted on a pivot stud against the force of a tension spring, and rotatably supported in a roller sleeve by a bearing.

The prior art tensioners rely upon an arrangement wherein the eccentric portion is contained within a bearing radius. This limits the movement and adjustability of the prior art tensioner to that of a predetermined radius for the moveable eccentric portion. If the predetermined radius is exceeded by belt stretch for example, the tensioner looses effectiveness. This is generally the case as a belt wears. Further, the prior art eccentric tensioners are relatively complex and require additional machining to produce the components with the proper form and fit.

What is needed is a tensioning idler having an outer belt bearing ring with an axis of rotation that is moveable in a plane. What is needed is a tensioning idler having an outer belt bearing ring with an axis of rotation that is moveable in a plane with respect to an inner ring axis of rotation. What is needed is a tensioning idler having an eccentric movement disposed outside of a bearing. The present invention meets these needs.

### SUMMARY OF THE INVENTION

The primary aspect of the invention is to provide a tensioning idler having an outer belt bearing ring with an axis of rotation that is moveable in a plane.

Another aspect of the invention is to provide a tensioning idler having an outer belt bearing ring with an axis of rotation that is moveable in a plane with respect to an inner ring axis of rotation.

Another aspect of the invention is to provide a tensioning idler having an eccentric movement disposed outside of a bearing.

Other aspects of the invention will be pointed out or made obvious by the following description of the invention and the accompanying drawings.

The invention comprises a tensioning idler. An outer belt bearing ring is resiliently engaged to an inner ring. The belt bearing ring and inner ring each rotate about an axis of rotation. The belt bearing ring is connected to the inner ring with the resilient material whereby the belt bearing ring rotates about an axis of rotation that is eccentrically moveable in a plane with respect to an inner ring axis of rotation. The resilient material imparts a belt tension as the belt bearing ring rotates. The resilient material may comprise springs, compressible fluids, incompressible fluids, or elastomers or a combination of the foregoing. The tensioner is mounted on an engine, bracket, or other device.

### BRIEF DESCRIPTION OF THE DRAWINGS

FIG. 1 is a cross-sectional side view of the inventive tensioning idler.

FIG. 2 is a detail of a coil spring.

FIG. 3 is a cross-sectional side view of an alternate embodiment.

FIG. 4 is a cross-sectional side view of an alternate embodiment.

FIG. 5 is a detail of a leaf spring.

FIG. 6 is a cross-sectional side view of an alternate embodiment.

FIG. 7 is a detail of a chamber.

FIG. 8 is a cross-sectional side view of an alternate embodiment.

FIG. 9 is a detail of a rubber wheel.

FIG. 10 is a cross-sectional side view of an alternate embodiment.

FIG. 11 is a detail of a leaf spring.

FIG. 12 is a cross-sectional side view of an alternate embodiment.

FIG. 13 is a detail of a steel strip spring.

FIG. 14 is a cross-sectional perspective view of the inventive tensioner under load.

FIG. 15 is a cross-sectional perspective view of the inventive tensioner with no load.

### DETAILED DESCRIPTION OF THE INVENTION

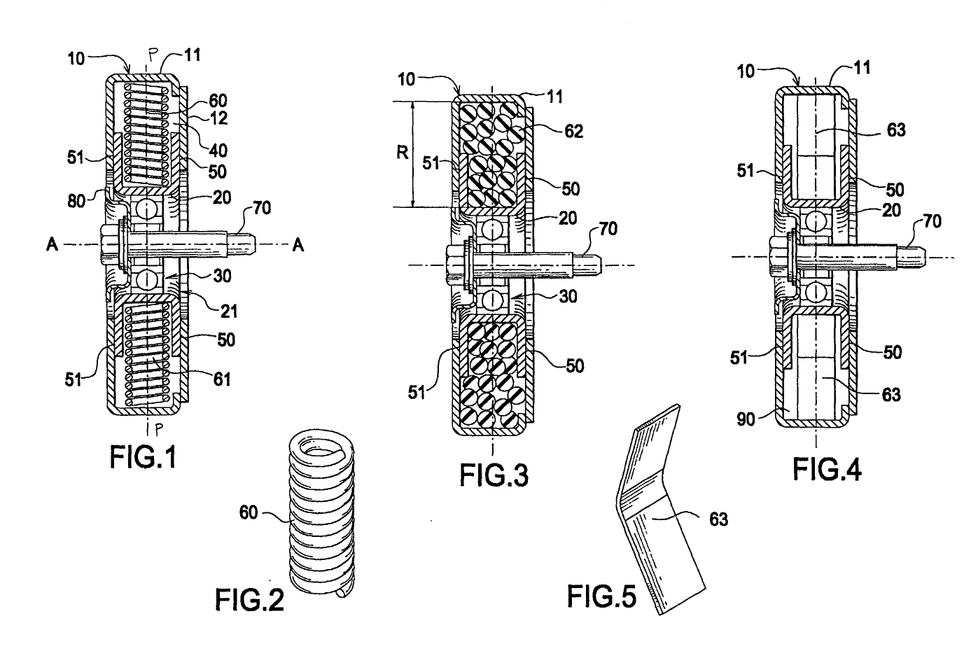

FIG. 1 is a cross-sectional side view of the inventive tensioning idler. Belt bearing ring 10 is substantially circular and has a “U” cross section. Inner ring 20 is also substantially circular and has an inverted “U” cross section with respect to the outer ring 10. Inner ring 20 is journaled to shaft 70 by bearing 30. Bearing 30 comprises a ball bearing, but may also comprise any anti-friction bearing suitable for the use described herein, or its equivalents. Inner ring 20 is engaged with an outer race of bearing 30.

Belt bearing ring 10 and inner ring 20 cooperate to define a chamber 40 that contains a resilient member 60.

One or more damping surfaces 50, 51 may be used between inner ring 20 and belt bearing ring 10. Damping surfaces 50, 51 comprise a plane of sliding, frictional engagement having a coefficient of friction disposed between belt bearing ring 10 and a member 12, and belt bearing ring 10 and inner ring 20. Damping surfaces 50, 51 act to damp a movement of belt bearing ring 10 relative to inner ring 20 during operation. Damping rings 50, 51 also act as a seal to keep contaminants from entering the chamber 40.

Belt bearing ring 10 and inner ring 20 may comprise any suitable material, including steel, aluminum, magnesium, thermoset plastic or thermoplastic material, or any combination or equivalent thereof. Inner ring 20 and belt bearing ring 10 may also comprise any lightweight material, including nylon, or equivalents, to reduce centrifugal forces created during operation. In the preferred embodiment, inner ring 20 and outer ring 10 each comprise Nylon 6.6 with PTFE, and may or may not comprise a damping material having a coefficient of friction for surfaces 50, 51.

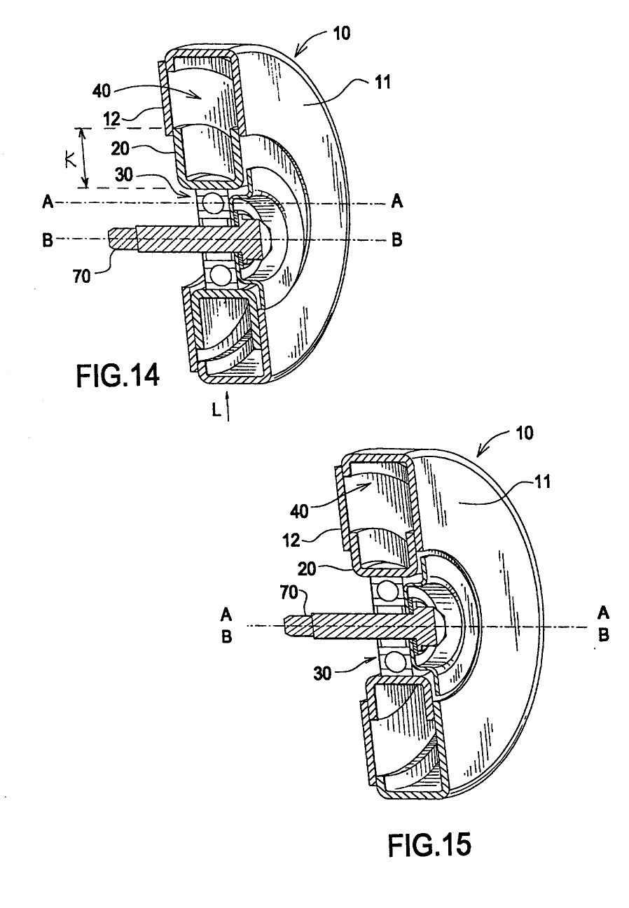

Damping surfaces 50, 51 in the preferred embodiment comprise PTFE. A diameter and thickness of both the inner ring and outer ring can be any size as required by the design. A diameter of belt bearing ring 10 can be selected to create any operational amplitude as may be needed by a system, see FIG. 14.

For ease of assembly, belt bearing ring 10 may comprise two parts, an “L” section 11, and member 12 to be put on an open side of the “L” section 11 when fully assembled. Member 12 is attached to L section 11 after assembly of resilient member 60 in chamber 40.

Resilient member 60 comprises a member having a spring rate, depending on the damping, amplitude, or belt tension (load) required by the system. The spring in FIG. 1 is a coil spring 61. Two or more coil springs may be used in chamber 40, each of which extends radially between inner ring 20 and outer ring 10. The number of springs 61 is determined by the particular system requirements.

Post 70 is used to attach the inventive idler to a mounting surface (not shown), such as the surface of an engine. Post 70 may comprise a threaded connector or press-fit stud, or equivalents thereof. Dust cover 80 prevents dirt and debris from entering bearing 30.

In operation, an axis of rotation A-A of outer ring 10 is moveable in a plane that is normal to the axis of rotation, see FIG. 14. An axis of rotation B-B of inner ring 20 is substantially parallel to the axis of rotation of outer ring 10. More particularly, an axis of rotation is substantially parallel to axis A-A and normal to a plane P/P. In this way an eccentric movement of belt bearing ring 10 is disposed outside of bearing 30. That is, bearing 30 does not move eccentrically with respect to a mounting post 70 as in the prior art, instead ring 10 moves eccentrically about the inner ring 20 and thereby eccentrically about a bearing 30.

FIG. 2 is a detail of a coil spring. Coil spring 60 has a predetermined spring rate as required by an operating condition.

FIG. 3 is a cross-sectional side view of an alternate embodiment. The parts shown in FIG. 3 are as described for FIG. 1 with the exception that resilient member 60 comprises elastic balls 62. Small spherical elastomer balls fill chamber 40 to the extent allowed by their spherical shape. The air space between balls 62 allows movement and deformation of the balls under load. This, in turn, allows a controlled planar movement of belt bearing ring 10 axis of rotation with respect to the inner ring 20. It is preferred that a diameter of each ball be approximately 1/6^{th} or less of a radial distance R from the inner ring 20 to ring 10 in order to facilitate a fluid-like movement or behavior of the balls 62 comprising resilient member 60 during operation.

FIG. 4 is a cross-sectional side view of an alternate embodiment. The parts shown in FIG. 4 are as described for FIG. 1 with the exception that a resilient member 60 comprises a plurality of leaf springs 63. Each leaf spring 63 extends radially from inner ring 20 to ring 10 in chamber 40. During operation each leaf spring flexes thereby allowing a controlled planar movement of a ring 10 axis of rotation A-A with respect to the inner ring 20.

FIG. 5 is a detail of a leaf spring. Leaf spring 63 having a predetermined deflection to facilitate a movement of ring 10 during operation.

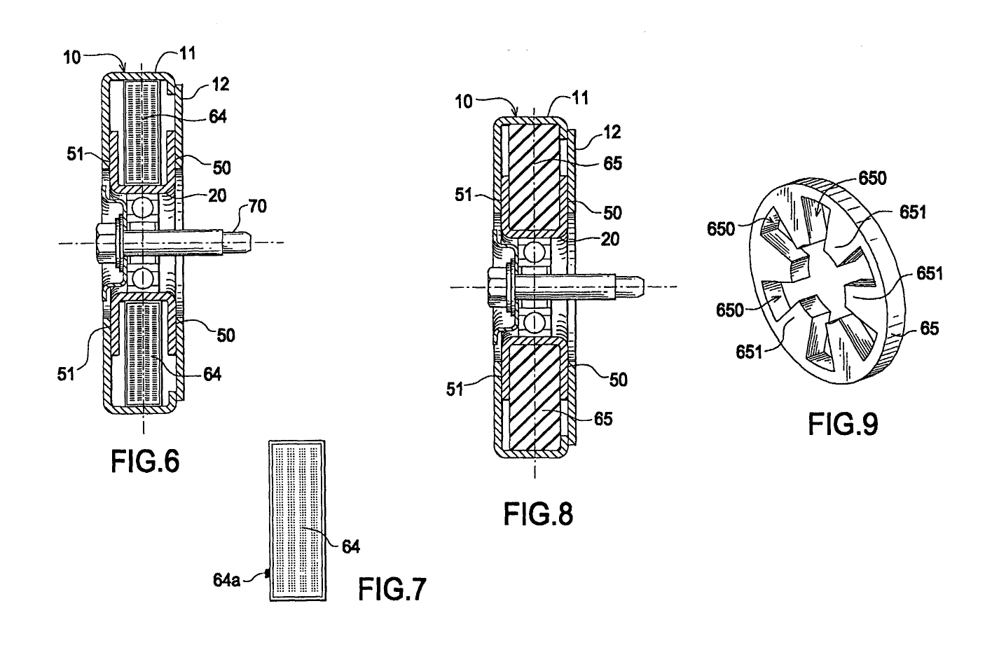

FIG. 6 is a cross-sectional side view of an alternate embodiment. The parts in FIG. 6 are as described for FIG. 1 with the exception that the resilient member 60 comprises fluid chamber 64. Chamber 64 is contained in chamber 40. Chamber 64 may contain any fluid, including a compressible gas, or an incompressible liquid or liquids of various viscosities. Chamber 64 may also contain any moveable solid, for example in a granular form, or a combination of or equivalents of any of the foregoing. The material in chamber 64 may be displaced from side to side, compressed, or a combination of both. Chamber 64 may comprise a flexible elastomer to match the shape of chamber 40. Chamber 64 may be permanently sealed or have a valve for pressure and volume adjustments in the case of a compressible fluid. One skilled in the art can appreciate that a pressure of a compressible fluid in chamber 64 can be adjusted to accommodate operational changes as well. A movement of a fluid contained in chamber 64 allows a controlled planar movement of a ring 10 axis of rotation A-A with respect to the inner ring 20.

FIG. 7 is a detail of a fluid chamber. Valve 64a may be used to vary a pressure in chamber 64 in response to an operating condition.

FIG. 8 is a cross-sectional side view of an alternate embodiment. The parts in FIG. 8 are as described for FIG. 1 with the exception that the resilient member 60 comprises a resilient wheel 65. Wheel 65 may comprise an elastomeric ring. Wheel 65 may have a solid form, or comprise slots 650 to allow for compression deformation of spokes 651. Flexing of wheel 65 allows a controlled planar movement of a ring 10 axis of rotation A-A with respect to the inner ring 20. Elastomeric wheel 65 may comprise any natural or synthetic rubber, or any combination thereof, including equivalents.

FIG. 9 is a detail of a rubber wheel. Wheel 65 comprises spokes 651 with interspersed gaps 650.

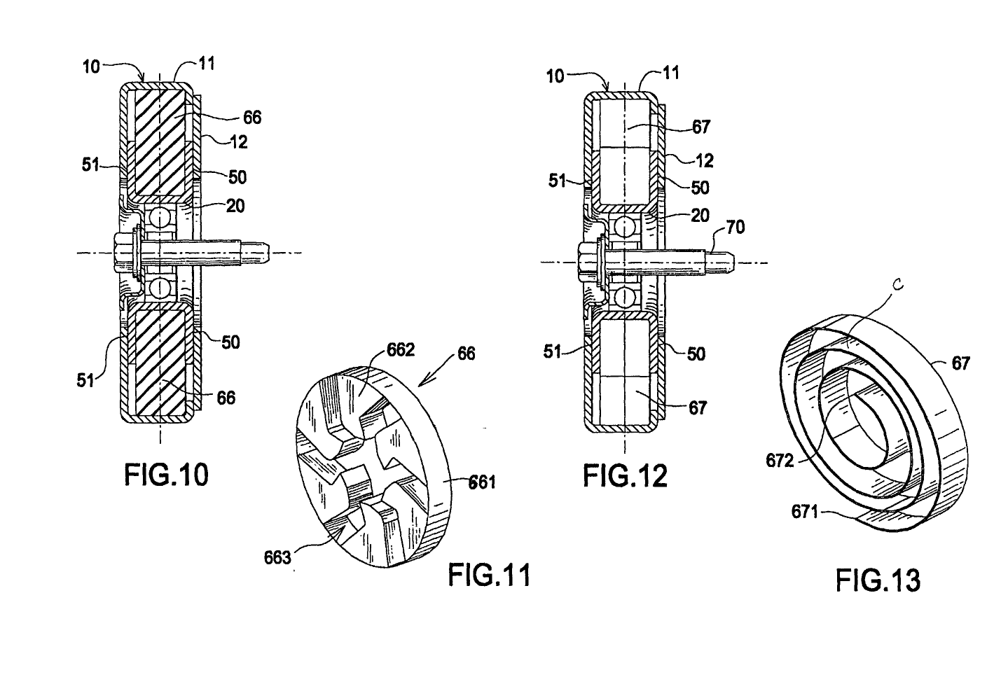

FIG. 10 is a cross-sectional side view of an alternate embodiment. The parts in FIG. 10 are as described for FIG. 1 with the exception that the resilient member 60 comprises continuous leaf spring 66. Spring 66 comprises a continuous series of leaf spring spokes 662 which extend radially toward the inner ring 20 from an outer circumference 661 in a zigzag arrangement. Each leaf spring has a spring rate adjusted according to a particular system operating condition. Flexing of each leaf spring spoke 662 allows a controlled planar movement of a ring 10 axis of rotation A-A with respect to the inner ring 20.

FIG. 11 is a detail of a leaf spring. Spring 66 comprises spokes 662 with interspersed gaps 663. A spring rate may be adjusted depending upon an operating requirement.

FIG. 12 is a cross-sectional side view of an alternate embodiment. The parts in FIG. 12 are as described for FIG. 1 with the exception that the resilient member 60 comprises steel strip spring 67 formed in a generally spiral shape. A first end 672 is engaged with inner ring 20. A second end 671 is engaged with outer ring 10. Rotational and radial flexing of the steel strip spring allows a controlled planar movement of a ring 10 axis of rotation A-A with respect to the inner ring 20.

FIG. 13 is a detail of a steel strip spring. Spring 67 may comprises a number of coils C as required by an operating condition.

In each embodiment, the resilient member that is on the side of the belt bearing ring that is touching the belt (contact side) is under compression. The opposite side (180 degrees from the contact side) is under tension, or is under no load.

One can appreciate that the instant invention is more compact than prior art tensioners due to the compact nature of the components and the manner in which they are assembled and operate. For example, the inventive tensioner does not comprise an “arm” as used in numerous prior art tensioners. This results in a considerable space saving as compared to larger prior art tensioners.

FIG. 14 is a cross-sectional perspective view of the inventive tensioner under load. As one can see, an axis of rotation A-A of belt bearing ring 10 does not coincide with an axis B-B of inner ring 20 when the inventive tensioner is subject to a belt load. The depicted configuration would result from a belt load L being applied as shown to belt bearing ring 10. An amplitude of movement of ring 10 relative to ring 20 is dependent upon a dimension K of ring 20.

FIG. 15 is a cross-sectional perspective view of the inventive tensioner with no load. Under no load that A-A and B-B of belt bearing ring 10 and inner ring 20 are concentric. Compared to FIG. 14 one can readily see that the axis of rotation A-A of the belt bearing ring 10 is moveable in a plane extending normally to the axis of rotation A-A. Axis of rotation A-A is moveable independently of an axis of rotation B-B of the inner ring 20.

Although various forms of the invention has been described herein, it will be obvious to those skilled in the art that variations may be made in the construction and relation of parts without departing from the spirit and scope of the invention described herein.

We claim:

1. A tensioning idler comprising:
an outer member having an axis of rotation;
an inner member having an axis of rotation, the outer member moveably engaged with the inner member; and
the outer member axis of rotation moveable in a plane, the plane extending substantially normal to the inner member axis of rotation.

2. The tensioning idler as in claim 1 further comprising:
a resilient member engaged between the inner member and the outer member; and
the inner member journaled to a shaft.

3. The tensioning idler as in claim 2, wherein the outer member comprises a belt bearing surface.

4. The tensioning idler as in claim 2, wherein the resilient member comprises a spring.

5. The tensioning idler as in claim 2, wherein the resilient member comprises a fluid.

6. The tensioning idler as in claim 2, wherein the resilient member comprises an elastomeric material.

7. The tensioning idler as in claim 2 comprising:
the inner member and the outer member having a sliding frictional engagement in order to damp a movement between the inner member and the outer member.

8. The tensioning idler as in claim 5, wherein the fluid comprises a compressible fluid.

9. The tensioning idler as in claim 7 further comprising a bearing engaged with the inner member.

10. The tensioning idler as in claim 2 further comprising a shaft for mounting the bearing to a surface.

11. A tensioner comprising:
a rotatable bearing;
a circular member engaged with the rotatable bearing; and
the circular member eccentrically moveable with respect to the rotatable bearing.

12. The tensioner as in claim 11 further comprising:
a resilient member disposed between the circular member and the rotatable bearing.

13. The tensioner as in claim 12 further comprising:
an inner member engaged with the rotatable bearing; and
the inner member and the circular member each having a surface having a sliding frictional engagement in order to damp a relative movement between the inner member and the circular member.
